(19) United States
(12) Patent Application Publication
(10) Pub. No.: US 2007/0291797 A1
(43) Pub. Date: Dec. 20, 2007

(54) Method of packet data transmission

(76) Inventor: Anil M. Rao, Cedar Knolls, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/455,680

(22) Filed: Jun. 19, 2006

(51) Int. Cl. H04J 3/06

(52) U.S. Cl. 370/503; 370/350

(57) ABSTRACT

A method of transmitting data packets using a staggered transmission technique by which some transmissions of data packets may be delayed to reduce periodicity inherently caused by synchronous retransmission schemes. The amount of delay should be minimal in order to not adversely effect applications with tight latency constraints, such as Voice over Internet Protocol (VoIP). The delay may be applied to initial transmissions or retransmissions of data packets.

### FIELD OF THE INVENTION

The present invention relates generally to wireless communication systems and, in particular, to packet data transmission in wireless communication systems.

### BACKGROUND OF THE RELATED ART

In wireless communication systems based on the well-known Universal Mobile Telecommunication System (UMTS) standard, voice services implemented in the form of Voice over Internet Protocol (VoIP) may be problematic for hearing aid devices. VoIP involves transmitting VoIP packets from a mobile station to a base station, i.e., uplink, over a high speed data channel known as Enhanced Dedicated CHannel (E-DCH) using Hybrid Automatic ReQuest (HARQ).

During talk spurts, a new VoIP packet is generated and transmitted every 20 ms, wherein a VoIP packet comprises a Real Time Protocol (RTP) packet with a 20 ms Adaptive Multi-Rate speech frame encapsulated therein. Each VoIP packet is transmitted over a 2 ms transmission time interval (TTI) on the E-DCH. FIG. 1 depicts a series of VoIP packets 100 being initially transmitted in accordance with the prior art. A new VoIP packet 1-5 is transmitted every 20 ms over a 2 ms TTI on the E-DCH. For example, VoIP packet 1 is transmitted at time t0, VoIP packet 2 is transmitted at time t10, and so on.

Errors occurring in the transmission of VoIP (or other data) packets are controlled using Hybrid Automatic ReQuest (HARQ). As implemented in UMTS, HARQ is a synchronous retransmission scheme. When a VoIP (or other data) packet transmission is received with errors, i.e., failed VoIP packet transmissions, the same VoIP packet (or some derivative thereof) is to be retransmitted at some fixed interval after a failed VoIP packet transmission began. Such retransmission continues until the VoIP packet transmission is successfully received or until a maximum number of allowable retransmissions is reached. To accommodate tight latency constraints for time sensitive applications, such as VoIP, HARQ is configured to retransmit VoIP (or other data packets) 16 ms after a failed VoIP (or other data) packet transmission began. The maximum number of allowable retransmissions is typically set to three.

FIG. 2 depicts the series of VoIP packets 200 of FIG. 1 being transmitted using HARQ in accordance with the prior art. Each VoIP packet retransmission begins 16 ms after a failed VoIP packet transmission began. Retransmissions are noted as 1x, 2x and 3x corresponding to a first, second and third retransmission, respectively.

Synchronous retransmission schemes, such as HARQ, inherently produce periodicity. In UMTS, periodicity of VoIP packet transmissions may occur at a frequency as small as 4 ms, e.g., 4 ms time intervals separates the starts of the third retransmission of VoIP packet 2 at time t34, the second retransmission of VoIP packet 3 at time t36, the first retransmission of VoIP packet 4 at time t38 and the initial transmission of VoIP packet 5 at time t40. The frequency of 4 ms or 250 Hz, however, is within a range of frequencies that causes interference to hearing aid devices. Accordingly, there exists a need for implementing VoIP without causing interference to hearing aid devices.

### SUMMARY OF THE INVENTION

An embodiment of the present invention is a method of transmitting data packets using a staggered transmission technique by which some transmissions of data packets may be delayed to reduce periodicity inherently caused by synchronous retransmission schemes. The amount of delay should be minimal in order to not adversely effect applications with tight latency constraints, such as Voice over Internet Protocol (VoIP). The delay may be applied to initial transmissions or retransmissions of data packets.

### BRIEF DESCRIPTION OF THE DRAWINGS

The features, aspects, and advantages of the present invention will become better understood with regard to the following description, appended claims, and accompanying drawings where:

FIG. 1 depicts a series of VoIP packets being transmitted in accordance with the prior art;

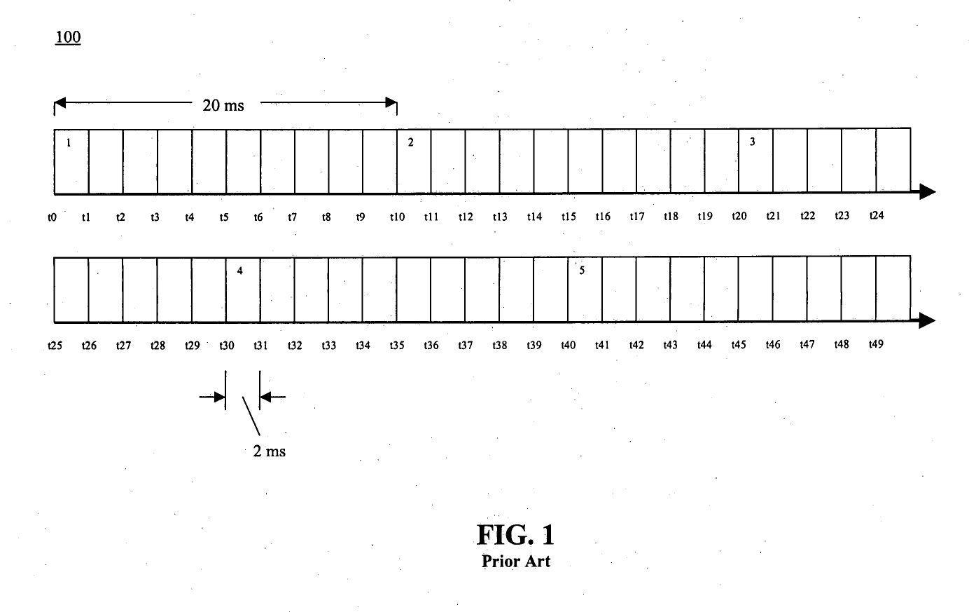

FIG. 2 depicts the series of VoIP packets of FIG. 1 being transmitted using HARQ in accordance with the prior art; and

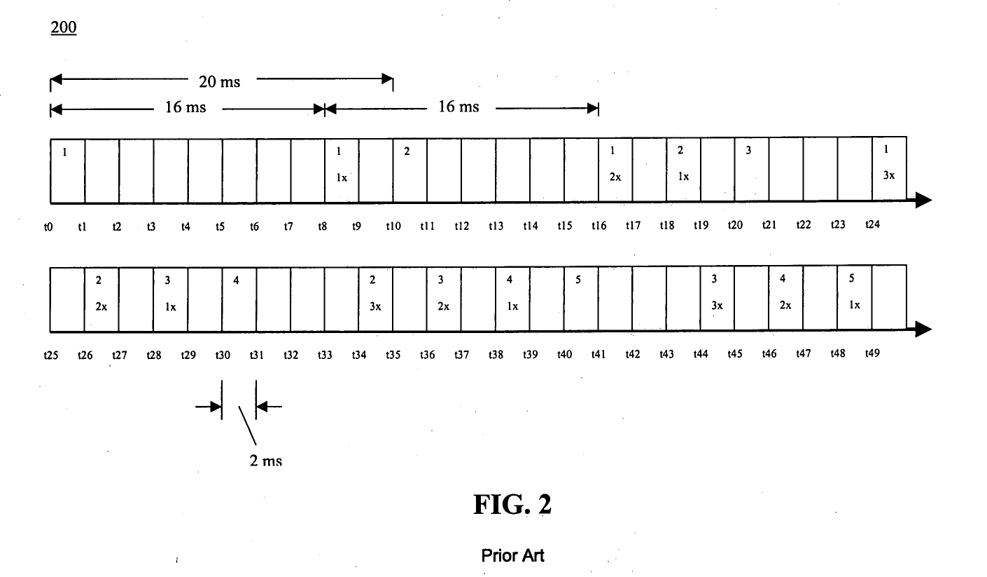

FIG. 3 depicts a series of VoIP packets being transmitted over the E-DCH in accordance with one variation of a first embodiment;

FIG. 4 depicts a series of VoIP packets being transmitted over the E-DCH in accordance with one variation of a second embodiment; and

FIG. 5 depicts a series of VoIP packets being transmitted over the E-DCH in accordance with one variation of a third embodiment.

### DETAILED DESCRIPTION

An embodiment of the present invention is a method of transmitting data packets using a staggered transmission technique by which some transmissions of data packets may be delayed to reduce periodicity inherently caused by synchronous retransmission schemes. The amount of delay should be minimal in order to not adversely effect applications with tight latency constraints, such as Voice over Internet Protocol (VoIP).

For purposes of illustration, the present invention will be described herein with respect to VoIP in an Universal Mobile Telecommunication System (UMTS) based wireless communication system. This should not be construed to limit the present invention in any manner. It would be apparent to a person of skill in the art to apply the present invention to wireless communication systems based on some other multiple access technique and to other types of applications.

In the UMTS based wireless communication system of the present invention, VoIP packets are transmitted by a mobile station to a base station over a high speed uplink data channel known as Enhanced Dedicated CHannel (E-DCH). The E-DCH comprises an Enhanced Dedicated Physical Data CHannel (E-DPDCH) and an Enhanced Dedicated Physical Control CHannel (E-DPCCH).

During talk spurts, a new VoIP packet is generated every x ms by a transmitting entity, where x>0. The VoIP packet may be generated using an Adaptive Multi-Rate (AMR) vocoder or some other type of vocoder, which generates x ms speech frames. Each VoIP packet is transmitted over a 2 ms (or some other duration) transmission time interval (TTI) over the E-DCH. For example, in UMTS, the AMR vocoder is used to generate 20 ms speech frames. The speech frames are subsequently encapsulated using the well-known Real Time Protocol (RTP) to produce new VoIP packets every 20 ms during talk spurts.

A receiving entity responds to receipt of a VoIP packet in one of the following manners. If the VoIP packet was successfully received, the receiving entity sends an ACKnowledgement (ACK) to the transmitting entity to indicate successful reception thereof. Otherwise, the receiving entity sends a Negative ACKnowledgement (NACK) to the transmitting entity to indicate unsuccessful reception of the VoIP packet.

Errors occurring in the transmission of VoIP (or other data) packets are controlled using Hybrid Automatic ReQuest (HARQ). In an embodiment, HARQ is implemented as a synchronous retransmission scheme. When a NACK is received by the transmitting entity, HARQ will attempt to retransmitted the same data packet or derivative thereof y ms after a failed VoIP packet transmission began, i.e., VoIP packet transmission associated with NACK, where y>0. Such retransmissions of VoIP packets (or data packets) are also referred to herein as “synchronous retransmissions.” VoIP packet retransmissions may continue until an ACK is received or until a maximum number of allowable retransmissions is reached, e.g., 3 or 4. Each VoIP packet retransmissions of the same data packet or derivative thereof are collectively referred to herein as a “HARQ set”.

In an embodiment of the present invention, transmissions of the initial VoIP packet or retransmissions thereof can be staggered to reduce periodicity inherent with synchronous retransmission schemes, such as HARQ. The present invention will be described herein with respect to several embodiments of uplink data packet transmissions. In a first embodiment, transmissions are staggered by delaying some VoIP packets one or more TTIs before they are initially transmitted. Synchronous retransmissions of VoIP packets would begin after failed VoIP packet transmissions.

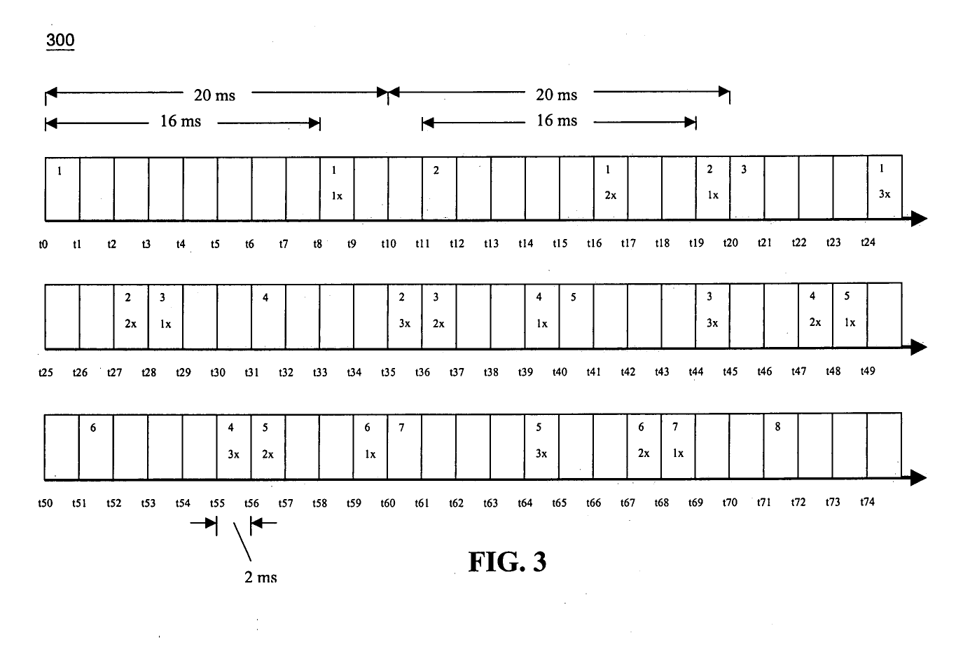

FIG. 3 depicts a series of VoIP packets 300 being transmitted over the E-DCH in accordance with one variation of the first embodiment. A new VoIP packet is generated every 20 ms, i.e., x=20 ms, Every other new VoIP packet is delayed one TTI before being transmitted. Odd VoIP packets 1, 3, 5 and 7 are initially transmitted at the beginning of each 20 ms time interval. Even VoIP packets 2, 4, 6 and 8 are delayed one TTI after the start of each 20 ms time interval before they are initially transmitted. Retransmissions of VoIP packets 1-8 begin 16 ms (or some other fixed duration) after a corresponding failed VoIP packet transmission began, i.e., y=16 ms. Retransmissions are noted as 1x, 2x and 3x corresponding to a first, second and third retransmission, respectively. By delaying every other new VoIP packet transmission, periodicity inherently caused by synchronous retransmission schemes is reduced.

In other variations of the first embodiment, not every other VoIP packet is delayed one TTI before being initially transmitted. For example, every third or fourth VoIP packet may be delayed one or more TTIs before the initial transmission.

In a second embodiment, transmissions are staggered by delaying some, but not all, synchronous retransmissions. Synchronous retransmissions will begin y ms after failed VoIP packet transmissions began, wherein y>0. Delayed synchronous retransmissions will begin y+z ms after failed VoIP packet transmissions began, wherein z>0 corresponds to an amount of delay.

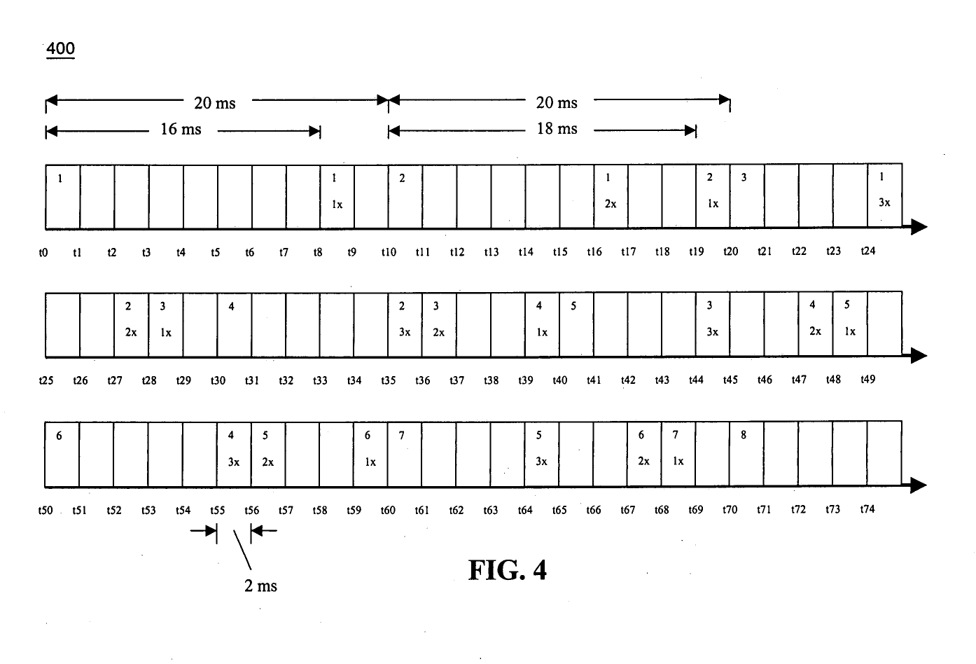

FIG. 4 depicts a series of VoIP packets 400 being transmitted over the E-DCH in accordance with one variation of the second embodiment. The initial VoIP packet is transmitted at the beginning of each 20 ms time interval, x=20 ms. Every other first synchronous retransmission of a VoIP packet is delayed one TTI, i.e., y+2 ms, after a failed initial VoIP packet transmission began. These retransmissions are also referred to herein as “delayed synchronous retransmissions.” All other retransmissions are synchronous retransmissions. First retransmissions of odd VoIP packets 1, 3, 5 and 7 are synchronously retransmissions that start a fixed interval of 16 ms after a failed initial VoIP packet transmission began, i.e., y=16 ms. By contrast, the first retransmissions of even VoIP packets 2, 4, 6 and 8 are delayed synchronous retransmissions that start the fixed interval plus one TTI after a failed initial VoIP packet transmission began, i.e., y+z=16+2=18 ms. Subsequent retransmissions of VoIP packets 1-8 will begin y ms after a corresponding failed VoIP packet retransmission began. Retransmissions are noted as 1x, 2x and 3x corresponding to a first, second and third retransmission, respectively. By delaying every other first synchronous retransmission, periodicity inherently caused by synchronous retransmission schemes is reduced.

In other variations of the second embodiment, not every other first retransmission is delayed one TTI. For example, every other second or third retransmission may be delayed one or more TTIs.

In a third embodiment, transmissions are staggered by imposing restrictions on when data packets can be transmitted, wherein the restrictions are configured to reduce periodicity. Data packet transmissions will not be permitted on some TTIs. TTIs in which data packet transmissions are not allowed are referred to herein as “restricted TTIs,” whereas TTIs in which data packet transmissions are allowed are referred to herein as “unrestricted TTIs.” Unless restricted, initial VoIP packet transmissions will begin at the start of x ms time intervals (during talk spurts) and synchronous retransmissions thereof, if necessary, will begin every y ms after a failed VoIP packet transmission began until a maximum number of allowable retransmissions is reached. If an initial transmission or synchronous retransmission of a VoIP packet was to begin during a restricted TTI, then the transmission will be delayed until the next unrestricted TTI. The restricted TTIs should be selected such that collision among data packet transmissions are avoided or minimized.

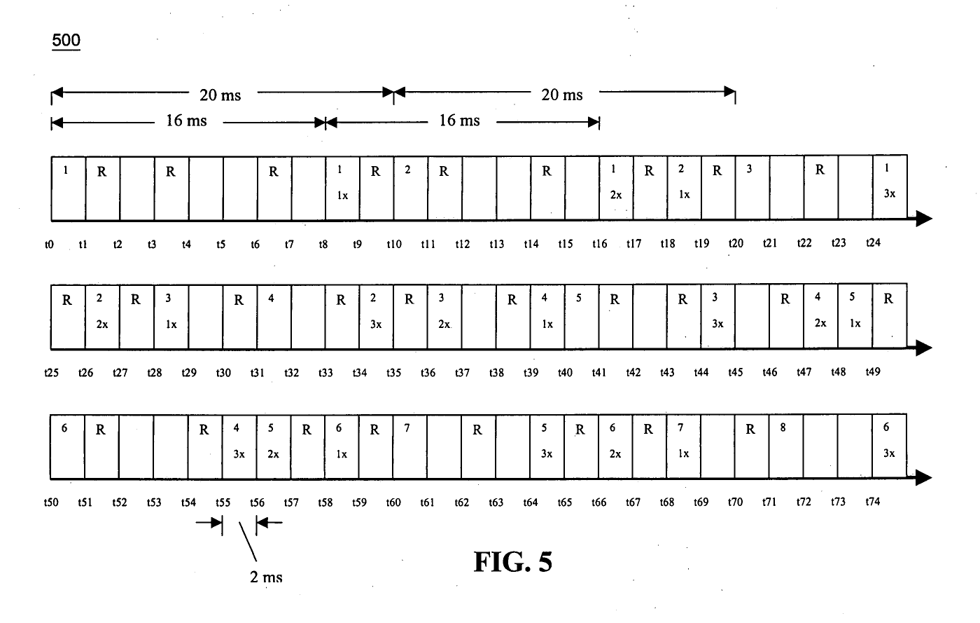

FIG. 5 depicts a series of VoIP packets 500 being transmitted over the E-DCH in accordance with one variation of the third embodiment. For every set of eight TTIs (also referred to herein as a “TTI set”), the second, fourth and seventh TTIs are designated as restricted TTIs. A capital “R” is used in FIG. 5 to indicated restricted TTIs. For example, the initial transmission of VoIP packet 4 was to start at t40, which is a restricted TTI. The initial transmission of VoIP packet 4 will be delayed one TTI before being transmitted at t42. Retransmissions of VoIP packet 4 will start 16 ms after failed transmissions of VoIP packet 4 began. Other variations of the third embodiment, the number of TTIs in a set may be different and the restricted TTIs may also be different.

Note that the restricted TTIs should be selected such that data packet transmissions avoid collisions with one another, i.e., multiple data packets being transmitted at a same time. In one embodiment where VoIP packets are being generated every 20 ms and the maximum number of allowable retransmissions is four or less, TTIs may be restricted in any manner so long as there are no adjacent restricted TTIs. Such restrictions would not delay a data packet transmission more than one TTI and avoid collisions with any other data packet transmissions.

In a fourth embodiment, transmissions are staggered using a pseudo-random sequence to indicate which data packet transmissions are to be delayed. For example, the pseudo random sequence comprises ones and zeroes, wherein a one might indicate not to delay a VoIP packet and a zero might indicate to delay a VoIP packet. In one embodiment, the pseudo-random sequence does not delay any data packet transmission more than one TTI.

Regardless of the embodiment, the manner in which the VoIP packets are staggered may be known to both the mobile station and the base station, or may be signaled between the mobile station and base-station. For example, in the first embodiment, both mobile station and base station know that every other initial VoIP packet transmission will be delayed one TTI. Or, in the fourth embodiment, the mobile station and base station can use a same pseudo-random generator to generate a same pseudo random sequence, or the random sequence could be signaled between the mobile station and base station over a control channel or other communication channel.

Although the present invention has been described in considerable detail with reference to certain embodiments, other versions are possible. Therefore, the spirit and scope of the present invention should not be limited to the description of the embodiments contained herein.

1. A method of transmitting data packets in a wireless communication system utilizing a synchronous retransmission scheme, the method comprising the steps:
transmitting data packets in a staggered manner by delaying a first portion of data packet transmissions, wherein the first portion comprises at least one data packet transmission but less than all data packet transmissions.

2. The method of claim 1, wherein the first portion includes less than all initial transmissions of the data packets.

3. The method of claim 2, wherein the first portion is delayed one transmission time interval.

4. The method of claim 2, wherein a second portion of data packet transmissions begin c ms after being generated, and the first portion of data packet transmissions begin c+d ms after being generated, c is greater than or equal to zero, and d is greater than zero.

5. The method of claim 2, wherein retransmissions of the first portion are synchronous retransmissions which begin y ms after failed transmissions of the data packets began, and y is greater than zero.

6. The method of claim 5, wherein the synchronous retransmissions begin 16 ms after the failed transmissions of the data packets began.

7. The method of claim 1, wherein the first portion includes less than all synchronous retransmissions of the data packets.

8. The method of claim 7, wherein the first portion is delayed a transmission time interval.

9. The method of claim 7, wherein the less than all synchronous retransmissions include less than all first synchronous retransmissions of the data packets.

10. The method of claim 7, wherein the less than all first synchronous retransmissions begin y+z ms after failed initial transmissions of the data packets began, all other first synchronous retransmissions of the data packets begin y ms after failed initial transmissions of other data packets began, and y and z are greater than zero.

11. The method of claim 7, wherein a second portion of data packet transmissions begin y ms after failed transmissions of data packets began, the first portion of data packet transmissions begin y+z ms after failed transmissions of data packets began, and y and z are greater than zero, and y and z are greater than zero.

12. The method of claim 11, wherein the second portion of data packet transmissions begin 16 ms after failed transmissions of data packets began, and the first portion of data packet transmissions begin 18 ms after failed transmissions of data packets began.

13. The method of claim 1, wherein the first portion includes data packet transmissions which were to begin during a restricted transmission time intervals.

14. The method of claim 1, wherein data packet transmissions are delayed based on a pseudo-random sequence.

15. The method of claim 14, wherein the pseudo-random sequence comprises zeros and ones for indicating whether to delay a corresponding data packet transmission.
